(19) United States
(12) Patent Application Publication
(10) Pub. No.: US 2004/0236950 A1
(43) Pub. Date: Nov. 25, 2004

(54) Method for digitally timestamping documents

(76) Inventor: Norman Carte, Costa Mesa, CA (US)

Correspondence Address: Norman Carte, Rutan & Tucker, LLP, 14th Floor, 611 Anton Blvd., P.O. Box 1950, Costa Mesa, CA, 92628-1950, US

(21) Appl. No.: 10/849,420

(22) Filed: May 18, 2004

Related U.S. Application Data
(60) Provisional application No. 60/472,263, filed on May 20, 2003.

(51) Int. Cl. H04L 9/00

(52) U.S. Cl. 713/176

(57) ABSTRACT

A method for timestamping a document includes making an entry into the document using a desired application, initiating a timestamping function from within the application, forming a hash of the entry, transmitting the hash to a timestamp authority, receiving a timestamp certificate from the timestamp authority, displaying information representative of the timestamp certificate in the document, and making another entry into the document.

### PRIORITY CLAIM

This patent application claims the benefit of the priority date of U.S. Provisional Patent Application Ser. No. 60/472,263, filed on May 20, 2003 and entitled METHOD FOR DIGITALLY TIMESTAMPING DOCUMENTS (Meyers Dawes Andras & Sherman docket no. NORM.PAP.01) pursuant to 35 USC 119. The entire contents of this provisional patent application are hereby expressly incorporated herein by reference.

### FIELD OF THE INVENTION

The present invention relates generally to digital timestamping. The present invention relates more particularly to a method for timestamping a document or a selected portion of a document from within a general purpose software application program.

### BACKGROUND OF THE INVENTION

The digital timestamping of documents to facilitate their authentication is well known. Digital timestamping uses mathematical techniques to provide an irrefutable, non-forgiving methodology for determining a date upon which a document existed. Any modification to a timestamped document is easily detected.

Thus, digital timestamps can be used to determine a date upon which a document existed and the document can provide confirmation or evidence that a transaction occurred or that information existed. For example, a digital timestamp can be used to determine a date upon which a will was executed, stock was purchased online, a bill of sale was provided, a bank deposit was made, or an invention was conceived.

Invention notebooks are one example of documents that benefit from the use of timestamping. Invention notebooks for recording information relating to inventions are well known. Such invention notebooks can aid in establishing the date of conception of an invention and in showing diligence in the subsequent development thereof.

Contemporary invention notebooks are typically bound paper notebooks having sequentially numbered pages and sewn bindings. Entries are made in such paper notebooks by writing and/or drawing on the pages thereof.

Entries in a contemporary paper invention notebook can be witnessed by others to help establish the date upon which the entries were made. Typically, witnessing includes signing and dating the notebook at the end of an entry or a series of entries. Witnesses can later testify that they recall witnessing the notebook on the date shown in the notebook.

Dedicated electronic invention notebooks are also known. Such dedicated electronic invention notebooks are dedicated solely to the use thereof as invention notebooks. This dedicated use may be contrasted to the more general use of general purpose word processing application programs. One example of a contemporary electronic invention notebook is LabTrack™, a product of Avatar Consulting of Mission Viejo, Calif. In such a contemporary electronic notebook, entries are typed into a computer file.

As used herein, the term “general purpose” is defined to describe software application programs that can generate and/or modify data files that are used for a variety of different purposes. Microsoft Word is one example of a general purpose software application program because it can generate and modify text documents used for a variety of different purposes, including purposes such as correspondence, records keeping, article writing, book writing, forms generation, list making, and note taking, as well as use in making an invention notebook.

Spreadsheet programs, database programs, and computer aided drafting programs such as Microsoft Excel, Microsoft Access, and AutoDesk AutoCAD, respectively, are also examples of general purpose software application programs, as the term is defined and used herein. Microsoft Excel can be used to generate and/or modify many different types of spreadsheets. Microsoft Access can be used to generate and/or modify many different types of databases. AutoDesk AutoCAD can be used to generate and/or modify many different types of drawings.

By way of contrast, Avatar Consulting's LabTrack™ is a dedicated invention notebook that is specifically designed and constructed for use as an invention notebook. Although LabTrack™ may be generically categorized as a word processing program, it is not well suited for general word processing use. Rather, LabTrack™ has features that make it best suited for the particular use of recording invention or laboratory information. As used herein, the term “dedicated” refers to such limited use software application programs that are specifically intended for more limited purposes.

Entries in a contemporary electronic invention notebook can be witnessed electronically via the use of digital signatures and digital timestamps to help establish the date upon which they are made. However, one disadvantage of such contemporary electronic invention notebooks is that they require that the user learn to use a new application program. Another disadvantage is that such dedicated electronic invention notebooks are generally costly. Another disadvantage is that such dedicated electronic invention notebooks are not suitable for general purpose use. Another disadvantage of such dedicated electronic invention notebooks is that they are not as widely available, as compared to general purpose word processing programs.

Yet another disadvantage of LabTrack™ and other such dedicated electronic invention notebooks is that timestamping must be performed on an entire document. That is, an entire invention notebook is timestamped, instead of a selected portion thereof. Thus, each time a new entry is made in the notebook, the entire notebook is timestamped and saved for future verification of the contents thereof. Of course, saving the entire invention notebook undesirably consumes much more storage than only timestamping and storing selected portions thereof, such as each new entry as that entry is completed.

It is also know to timestamp files produced by general purpose application programs, such as word processing programs. However, such timestamping of material produced by a general purpose application program, according to contemporary practice, must be performed on a file-by-file basis and must be performed outside of the general purpose application program. Timestamping on a file-by-file basis makes storage of the timestamped files very inefficient, as discussed above.

Further, requiring that timestamping be performed outside of the software application program makes timestamping undesirably complicated and difficult. Because such contemporary timestamping is undesirably complicated and difficult, its use discouraged. Thus, in many instances where timestamping would be beneficial, people fail to use it.

More particularly, according to contemporary practice, a file is produced (such as by making entries into a word processing software application program), the file is then saved and the software application program is exited, and then a separate program facilitates timestamping (such as by forming a hash of the file to be timestamped, transmitting the hash to a timestamping authority (TSA), receiving a timestamp certificate from the timestamping authority, and associating the timestamp certificate with the file).

As those skilled in the art will appreciate, such contemporary procedure is time consuming, cumbersome, and requires a substantial amount of learning new procedures.

Thus, although contemporary digital timestamping has proven generally useful for its intended purposes, it possesses inherent deficiencies that detract from its overall effectiveness and desirability.

Many people have a word processing software application program that they prefer to use. These people may already be very proficient in the use of their word processing software application program and frequently are reluctant to learn to use a dedicated contemporary electronic notebook. However, these same people may be willing to use their general purpose word processing application program as an invention notebook or in any other application where timestamping is desired, if the ability to easily and conveniently separately timestamp a plurality of sequential entries is built into the general purpose word processing program. This is also true for many other types of general purpose programs.

As such, although the prior art has recognized, to a limited extent, the problem of conveniently and efficiently timestamping invention notebook entries and other information, the proposed solutions have, to date, been ineffective in providing a satisfactory remedy.

In view of the foregoing, it is desirable to provide a method for timestamping only a desired portion of a document or other data file. It is also desirable to facilitate timestamping from within a general purpose software application program, thus eliminating the need for a user to have to save the data file and timestamp the data file from outside of the program.

### BRIEF SUMMARY OF THE INVENTION

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above-mentioned deficiencies associated with the prior art. More particularly, according to one aspect the present invention comprises a method for timestamping data, wherein the method comprises selecting at least a portion of a data file and initiating a timestamping process for the selected portion.

Initiating the timestamping process preferably comprises clicking on an icon in the toolbar of a software application program, preferably a general purpose software application program. The icon and/or the program code or macro that effects at least a portion of the timestamping process may be added to a pre-existing software application program as an aftermarket product. Alternatively, the icon and/or the program code or macro that effects at least a portion of the timestamping process may be integrated intimately (written into) into the code of the software application program.

According to one aspect, the present invention comprises clicking on an icon so as to effect timestamping, preferably of a portion of a document or data file. Alternatively, a selection from a drop down menu, any other type of menu or toolbar, or the like, may be made to initiate the timestamping process.

Typically, selecting at least a portion of a data file comprises selecting less than the entire data file. However, the entire file may optionally be selected, if desired.

Preferably, initiating the timestamping process is performed from within a software application program, such as by clicking on an icon in a toolbar of the software application program. The software application program may comprise a general purpose software application program, such as a word processing program, a database program, a spreadsheet program, or a CAD program. Indeed, the software application program may comprise any desired type of program.

Typically, the software application program will be a program that facilitates the generation of a data file. However, the software application program may alternatively be a program that uses a data file that was generated by another program. For example, the software application program may be a viewing program, either with or without editing capability.

Timestamping the selected portion of the data file may be facilitated by making the selected portion of the data file into a separate file. However, the selected portion of the data file may alternatively be timestamped without making the selected portion thereof into a separate file. That is, the selected portion of the data file may have a hash formed therefrom without being stored as a separate file, and the hash may then be communicated to a timestamping authority to have the timestamp generated thereby.

The hash may be formed by the general purpose software application program, by a macro, by another program called by the general purpose software application program, or in any other desired fashion.

Thus, according to one aspect of the present invention, the portion of the file to be timestamped is not saved as a separate file. If this portion of the file is not saved as a separate file, then it is preferably locked, protected, or otherwise kept from being modified, such that the hash formed therefrom remains valid.

Alternatively, that portion of the file to be timestamped is saved as a separate file. In this manner, the timestamped portion of the file is less likely to later be accidentally modified so as to invalidate the timestamp. Preferably, the timestamped file is stored in a manner that makes accidental and/or unauthorized access thereto more difficult and unlikely. For example, this file may have the attributes of hidden and/or read only. Further, this file may optionally be hidden or stored within a larger file, preferably one for which access is limited or denied. The timestamped file may be stored within a protected or hidden directory.

As a further option, any such stored files may be stored on read-only media, such as a CD-ROM. In this manner, the likelihood of unauthorized or accidental changes to such files is mitigated. Preferably, the timestamp is stored on the read-only media along with the timestamped file.

Preferably, selection of the desired portion of the data file to be timestamped is performed within the general purpose software application program. That is, the software application program itself is used to make the selection. For example, in many programs a selection may be made by high-lighting the desired material.

Alternatively, the selection may be that portion of the data file between a previously timestamped portion thereof and an end of the file or a position of a cursor. In this manner, any newly added portion of a data file, such as newly entered text in a text file, may easily be selected. Thus, new entries in a text document may conveniently be sequentially timestamped.

The selection may be made by forming a box around the desired material. This is a common method for selecting portions of CAD drawings and spreadsheets.

According to another aspect, the present invention comprises a method for timestamping data, wherein the method comprises initiating a timestamping process from within a general purpose software application program.

Either a portion of the data file or the entire data file may be selected and timestamped. The selection of the desired portion of the data file is preferably performed within the software application program itself.

According to another aspect, the present invention comprises a method for authenticating data, wherein the method comprises separately timestamping a plurality of selections within a data file.

According to another aspect, the present invention comprises a method for timestamping a document, wherein the method comprises making an entry into the document using a desired application program; initiating a timestamping function from within the application program; forming a hash of the entry; transmitting the hash to a timestamp authority; receiving a timestamp certificate from the timestamp authority; displaying the timestamp certificate within the document; and subsequently making another entry into the document.

Preferably, the hash is formed on a portion of the document. Alternatively, the hash may be formed upon the entire document.

The hash may be formed on a portion of the document without the portion of the document forming a file that is separate from a file that contains the document. Alternatively, the method of the present invention further comprises forming a file which contains the entry and which is separate from a file that contains the document and the hash is formed from the separate file.

Preferably, initiating a timestamping function is performed without exiting the document or other type of data file. Preferably, initiating a timestamping function is performed without exiting the application program. Preferably, timestamping is performed without the user explicitly saving the document. However, the document or a portion of the document may be saved by software according to the present invention.

Explicitly saving a document or other data file is defined herein as the user saving the file in the normal manner in which the user saves a file associated with the application program being used, such as by clicking on a save file icon. This definition does not include the timestamping software saving a file or a portion of a file. In this respect, any such saving by the software is somewhat transparent to a user and at least does not require a separate action by the user.

According to another aspect, the present invention comprises an invention notebook comprising a plurality of entries; a plurality of timestamps, each timestamp associated with an entry; wherein the timestamps are formed by a method comprising at least one of: (1) selecting a portion of a data file and initiating a timestamping process for the selected portion; and (2) initiating a timestamping process from within a general purpose software application program.

According to another aspect, the present invention comprises a macro or other add-on program for a software application program, such as a Visual Basic for Applications (VBA) macro for Microsoft Word, comprising a timestamping routine for facilitating timestamping of a portion of a document. The program is executable upon a general purpose computer, such as an IBM compatible personal computer or the like. Such a macro or other program may be provided as an aftermarket add-on for the software application program.

Preferably, the program comprises a setup routine for facilitating selection of a timestamping authority.

Preferably, the program comprises an opening routine for assembling a plurality of timestamped files to define a notebook or other document or data file.

Preferably, the program comprises code for providing a toolbar icon for facilitating initiation of the timestamping routine.

According to one aspect, the present invention comprises a method for timestamping a document, wherein the method comprises separately timestamping a plurality of entries within a notebook and wherein the notebook is formed by a general purpose application program.

According to one aspect, the present invention comprises a method for timestamping, wherein the method comprises operating a switch to initiate a timestamping process for device, such as a recording device. The switch may comprise, for example, a button. The switch may either be on the device itself, or may be somewhere else such as on a remote control for the device.

The device may comprise an audio and/or video recording device, such as a video recorder or camcorder. Timestamping may be useful when using a camcorder such as when something important is recorded and it is worthwhile to establish the time at which the recording occurred. A wireless Internet connection for the camcorder could be used to facilitate communication with the timestamp authority. Such a wireless Internet connection may be WiFi, Bluetooth, satellite, cellular or of any other desired type.

As used herein, the term Internet is by way of example and not by way of limitation. Alternatively, any other desired network, typically a wide area network (WAN), my similarly be used.

Alternatively, a wired connection to the Internet may be used. Other examples of recording devices include CD recorders, DVD recorders, floppy disk recorders, and magnetic tape recorders.

The recording device may alternatively be a printer (such as a laser printer or an inkjet printer), a scanner, a dedicated time stamp (such as a printing device that prints a timestamp onto paper, such as mail that has arrived at a law office), a telephone answering machine, or a surveillance camera.

Indeed, a timestamping button can, according to the present invention, be added to many different types of devices, such cellular telephones, personal data assistants (PDA's), notebook computers, laptop computers, desktop computers, and any other type of communication, recording, or computing devices.

For computer uses, it may be desirable to timestamp the arrival or reading of email, the viewing of a web page or other information. It may be desirable to timestamp various operations, communications, and displays on a computer.

It may be desirable to timestamp data recorded by a black box, such as those used on commercial airliners and proposed for use on various other types of vehicles, including passenger cars.

In may be useful to timestamp data generated or acquired from various laboratory equipment and test equipment. For example, it may be desirable to timestamp the results of a laboratory test by simply pushing a button on the test equipment that was used in the test.

It may be desirable to timestamp when a patient's chart or medical records were changed, such as when a doctor ordered a change in medication. This may be done on a PDA or tablet computer, for example. Timestamping can be initiated either with a switch, such as a button, or via the software (such as by clicking on an icon), as described herein.

The present invention may be used to timestamp cash transactions (such as the dispensing of cash from an ATM or the use of a cash register), credit transactions, or the purchasing or dispensing of tickets.

The device may be either in wired or wireless communication with the Internet, so as to effect communication with the timestamp authority.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

FIG. 1 is a flowchart showing generally an exemplary method for timestamping a document according to the present invention;

FIG. 2 is a flowchart showing the setup procedure of FIG. 1 in greater detail;

FIG. 3 is a flowchart showing the notebook opening procedure of FIG. 1 in greater detail;

FIG. 4 is a flowchart showing the procedure for making notebook entries of FIG. 1 in greater detail;

FIG. 5 is a flowchart showing the notebook closing procedure of FIG. 1 in greater detail;

FIG. 6A is a flowchart showing one embodiment of the timestamping procedure of FIG. 1 in greater detail, wherein a hash is generated from the last entry or entries directly from the notebook (without saving the entry or entries as a separate file); and

FIG. 6B is a flowchart showing another embodiment of the timestamping procedure of FIG. 1 in greater detail, wherein the hash is generated from a .TSX (timestamped) file that is saved separately with respect to the rest of the notebook (which may comprise a plurality of separate files).

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

According to one aspect, the present invention comprises forming a separate file each time that a portion of a data file is timestamped. However, this separate file is preferably formed by the software in a manner that is generally invisible to the user. That is, the user may be unaware that a separate file is being formed. This separate file is preferably timestamped in a fashion that is similar to contemporary file based time stamping. In this manner the consecutive timestamping of a plurality of entries in the data file results in a plurality of separate timestamped files. These timestamped files plus any untimestamped portions of the data file define the complete data file. When the data file is opened, or at any other desired time, the timestamped files and any untimestamped file or files are combined so as to form the complete file. This combining is preferably performed by the software in a manner that is generally invisible to the user. That is, the user may be unaware that separate files are being combined. Thus, the software of the present invention manipulates the data file by manipulating a plurality of separate files so as to facilitate easy to use, convenient timestamping. From a user's point of view, timestamping is occurring on a portion of the data file without the need to explicitly (by the user) save the data file and run separate timestamping software.

An exemplary application of the present invention, embodied as an invention notebook, is described in detail below. However, it is important to appreciate that embodiment of the present invention as an invention notebook is by way of example only, and not by way of limitation. Rather, the present invention may find use in a wide variety of different applications. For example, the present invention may be used in word processing, spreadsheet, database, CAD, financial transaction, stock trading, banking, bill paying, data storage, data transfer, as well as many other applications. Indeed, the present invention may be used to timestamp any type of data file and/or any desired portion of a data file.

According to the present invention, a general purpose application program, such as a general purpose word processor, is used to define an invention notebook, within which a user makes entries. Microsoft Word is one example of such a general purpose application program.

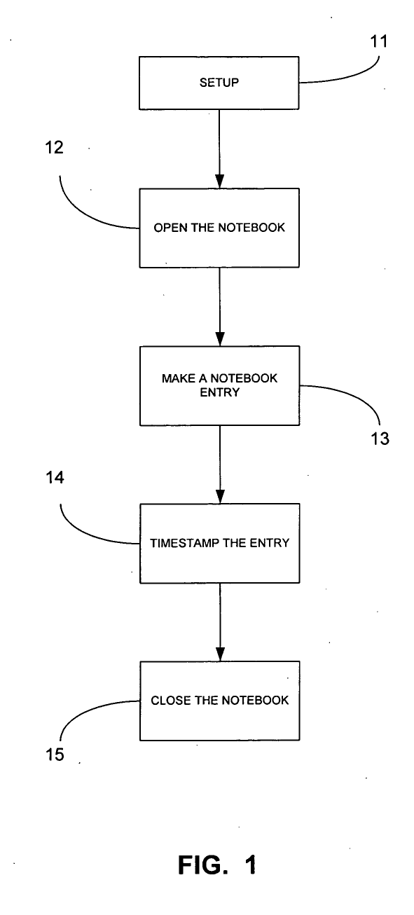

The present invention is illustrated in FIGS. 1-6B, which depict presently preferred embodiments thereof.

Referring now to FIG. 1, the method for timestamping a document according to the present invention is shown generally. A setup routine will typically be run before timestamping is performed, as shown in block 11. The setup routine will typically only need to be run one time. The setup routine allows the user to select a timestamping authority (TSA) and to make any other desired selection, such as those relating to customization of the notebook.

The notebook is opened as shown in block 12. The notebook can be a file having a name such as NOTEBOOK.DOC. The notebook can preferably be opened either from within the application program, or by selecting the file from a subdirectory as is facilitated by the Microsoft Windows operating systems.

A notebook entry is made as shown in block 13. That is, the user makes entries into the notebook by using the application program, such as Microsoft Word, in the manner in which the user is accustomed to using this application program. The entries may either be typed, drawn, or imported from elsewhere.

The entry is timestamped as shown in block 14. According to the present invention, timestamping is accomplished without requiring that the user explicitly save the entry or entries, without requiring that the user exit the general purpose application program, and without requiring that the user explicitly run another program. The entry or entries may be saved by the software of the present invention. Similarly, one or more programs may be run by the software of the present invention.

However, any such saving and/or running of additional programs that is performed, is performed in the background, such that the user does not need to take any additional action and such that the user may, indeed, be completely unaware that such saving and running of programs is occurring.

The notebook is closed after desired entries are made, as shown in block 15. The user may then use the general purpose application program for other desired purposes. For example, the user may use a general purpose word processor for other word processing activities besides for the entering of information into an invention notebook. These other activities may or may not involve timestamping.

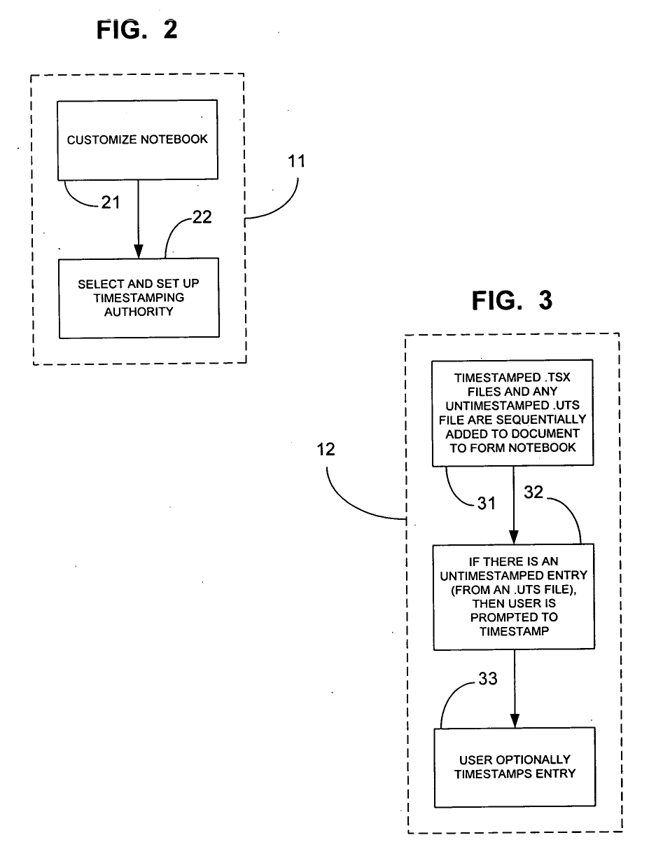

Referring now to FIG. 2, setup may optionally comprise customizing the notebook as shown in block 21 and/or selecting and setting up a timestamping authority as shown in block 22. Customizing the notebook may comprise selecting an appearance of the pages of the notebook. For example, some users may prefer a quadrille background. Borders and margins can also be specified. Several predefined templates may be provided for a user to select from.

Setting up a timestamping authority will facilitate convenient timestamping of notebook entries from within the general purpose application program. This will typically comprise entering an IP address to which a hash is sent. Account information may also be entered.

The setup procedure may be performed either when the software application program is first set up or installed, as would occur if timestamping were integrated with the software application program, or may occur when the timestamping feature is added to the software application program, such as via a macro or aftermarket program.

Referring now to FIG. 3, opening the notebook, according to one embodiment of the present invention, comprises sequentially assembling or concatenating a plurality of separate files into a single document to form the notebook as shown in block 31. According to another embodiment, the notebook comprises only one file and does not require such assembly.

Typically, there will be a plurality of .TSX files and possibly a single .UTS file. Files that contain entries that are about to be timestamped (and files that have already been timestamped) are assigned a .TSX extension. The .TSX files are created (and given the .TSX extension), according to one embodiment of the present invention, just prior to forming a hash as part of the timestamping process.

The X in the .TSX preferably is a number that indicates the sequence in which these files are to be assembled so as to form the notebook. Thus, five such files would be concatenated or assembled in the following order: .TS1, .TS2, .TS3, .TS4, and .TS5. However, those skilled in the art will appreciate that various other procedures for naming these files and for assembling them are likewise suitable. The use of .TSX for the naming convention is by way of example only and not by way of limitation. For example, any desired extension can be used and then the time that the files were made can be used to establish the desired order of assembly into the notebook.

Files which contain entries that have not yet been timestamped are assigned a .UTS extension. Generally, only the most recent entry in the notebook will be untimestamped. Thus, there can be many timestamped .TSX files, but there will typically be either zero or one untimestamped .UTS file. There will be zero untimestamped files if the most recent entry has been timestamped. There will be one untimestamped file if the most recent entry has not yet been timestamped.

Preferably, when the timestamping function is invoked, all entries that have not previously been timestamped are timestamped. Untimestamped entries are typically those entries that follow the last timestamped entry and can thus easily be bookmarked and saved as a single file.

Since the notebook is re-formed each time that it is opened by assembling the separate .TSX files and any .UTS file, the integrity of the notebook is maintained. That is, any changes made to the timestamped entries of the notebook from within the general purpose software application program are forgotten when the notebook is closed and thus are not reflected in the notebook when it is re-opened.

Not only does such re-assembly of the notebook maintain the integrity thereof, it also provides for convenience of the user. The user may manipulate the previously timestamped portions of the notebook as desired. For example, the user may find it convenient to add material to a previously timestamped portion of the notebook and then copy the edited material into a new entry. Any changes made to the timestamped portion of the notebook are lost when the notebook is closed and re-opened. Preferably, the user is notified that any changes to the timestamped portions of the notebook will not be saved when such changes are made.

Thus, previously timestamped entries cannot be tampered with or accidentally changed within the notebook document. Of course, the .TSX files could be altered, but such alteration would invalidate the timestamp. Preferably the .TSX files are hidden or protected, so that they cannot easily be altered.

Optionally, previously timestamped entries within the notebook are protected, so that they cannot be inadvertently changed (although such changes would not invalidate the timestamps of any .TSX files which would subsequently be used to reconstruct the notebook). This protection can be done using, for example, the Microsoft Word protection feature.

Alternatively, the previously timestamped entries can be made read-only. By making previously timestamped entries read-only, material can be copied therefrom, such as for use in untimestamped portions of the notebook.

Optionally, the user can be given the choice of making changes to previously timestamped portions of the notebook. For example, if the user attempts to make such a change, the user could be presented with a dialog box that informs the user that such changes are not permanent and will thus be lost when the document is closed. The user may then click on an OK button to proceed with such changes to the timestamped portion. This may be convenient for the user in some instances. As discussed above, changes to the timestamped portions of the notebook are not saved and are lost when the notebook is reconstructed from the individual .TSX files. Changes to the untimestamped portion of the notebook, such as the addition of text copied from the timestamped portion of the notebook, are saved (either in an untimestamped .UTS file or in timestamped .TSX files when the new entry is subsequently timestamped).

Thus, according to the preferred embodiment of the present invention, the general purpose software application program operates in much the same manner when using it as an invention notebook as it does when used for any other purpose. Changes can be made to any desired portion of the document. However, in order to make the use of timestamps meaningful, any changes to timestamped portions of the document are only temporary and will not be saved.

Preferably, the present invention makes backup copies of the .TSX files and also prohibits opening of the .TSX files directly (that is, without the .TSX file having been assembled into a notebook).

Returning now to FIG. 3, if there is an untimestamped .UTS file, then the user is prompted to timestamp this file as shown in block 32. This is merely a reminder, so that the user can optionally timestamp a previous entry, if desired, as shown in block 33.

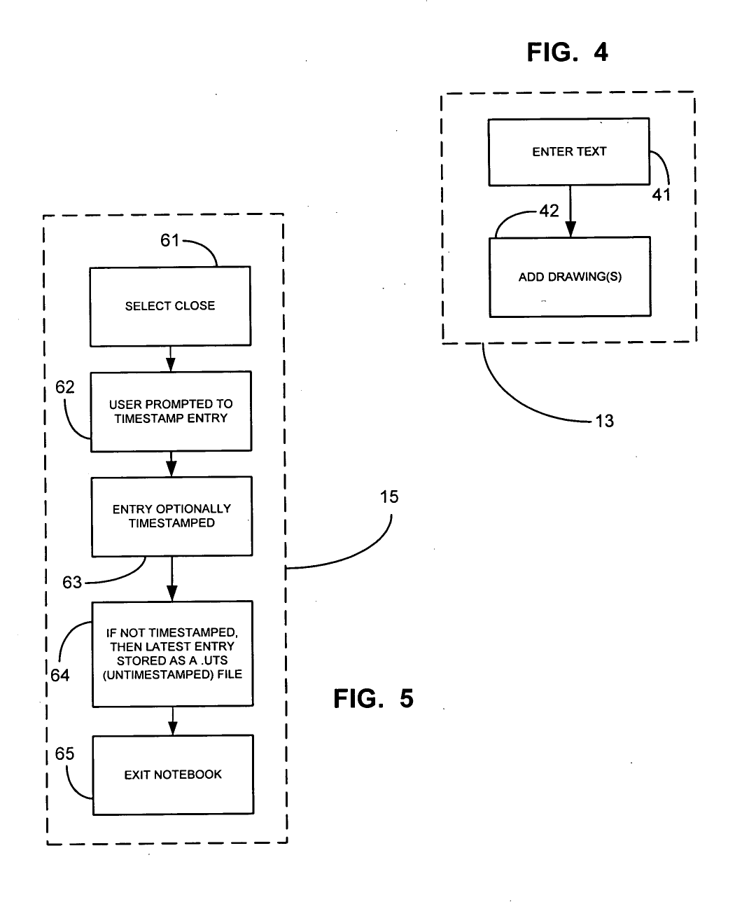

Referring now to FIG. 4, making a notebook entry can comprise entering text, as shown in block 41, and/or adding drawings, as shown in block 42. Entering text can comprise making tables. Entering text can also comprise importing text.

Adding drawings can comprise either making drawings directly within the general purpose application program or importing drawings. Indeed, the general purpose application program may comprise a drafting or CAD program.

Indeed, generally all of the features of the general purpose application program may be used to make an entry and/or to format the entry as desired.

Referring now to FIG. 5, closing the notebook preferably comprises selecting close, as shown in block 61. The user is optionally prompted to timestamp any untimestamped entry, as shown in block 62. If the user desires, the entry is timestamped as shown in block 63.

If the latest entry is not timestamped, then it is stored as a .UTS file. As mentioned above, files which contain entries that have not been timestamped are preferably assigned a .UTS extension and files which contain entries that have been or are about to be timestamped are preferably assigned a .TSX extension.

Exiting the notebook, as show in block 65, can comprise exiting the notebook document and/or exiting the general purpose application program entirely.

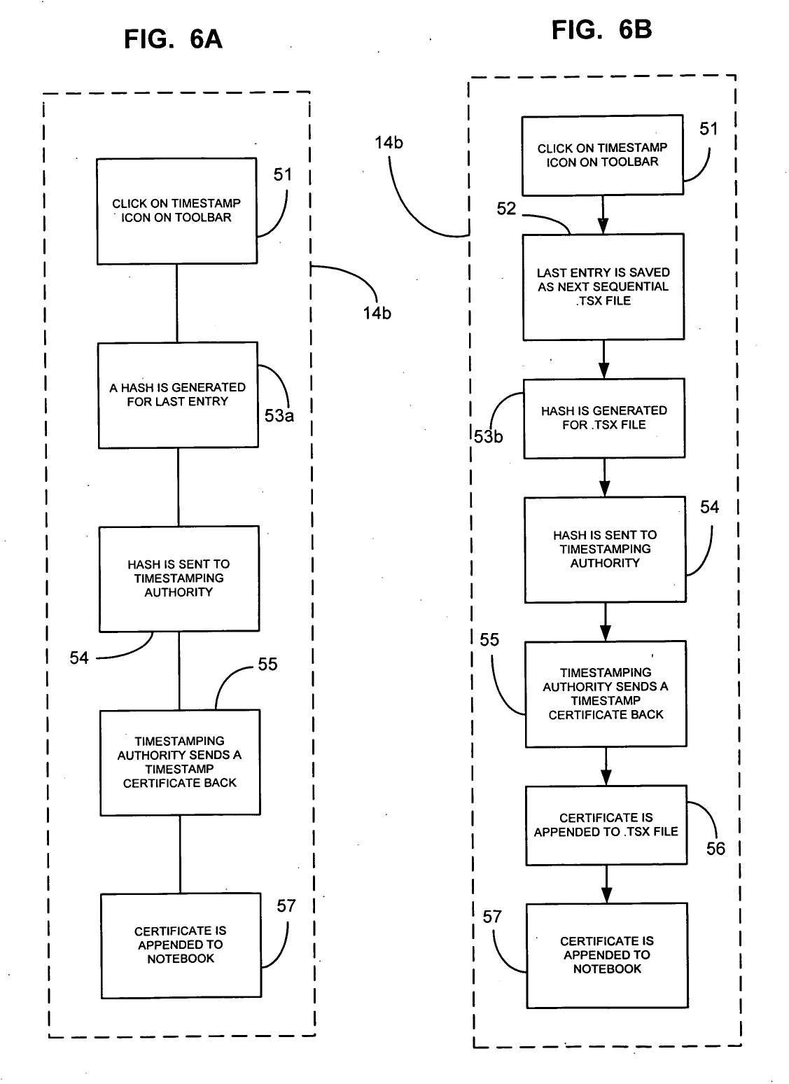

Referring now to FIGS. 6A and 6B, two alternative embodiments of the present invention are shown. According to the embodiment shown in FIG. 6A, a hash is generated from a portion of the notebook corresponding to the most recent entry or entries. The hash is generated without saving the portion of the notebook to a separate file.

According to the embodiment shown in FIG. 6B, the most recent entry or entries are saved to a separate file and the hash is generated from the separate file.

In either instance, flags, bookmarks, or the like are used to distinguish the most recent (untimestamped) entry or entries from earlier (timestamped) entries. As used herein, an entry is defined to include any material, e.g., text, graphics, or other data, added to the notebook since it was opened. Thus, by repeatedly opening the notebook, adding material, and closing the notebook—all without timestamping—multiple untimestamped entries are formed. However, for many practical purposes, these separate entries may generally be considered as a single entry.

When timestamping is initiated, all of the untimestamped entries are preferably timestamped together. Alternatively, the user may select which entries and/or which portions of entries are to be timestamped.

According to the embodiment of either FIG. 6A or FIG. 6B, the entries may comprise text, graphics, or any other type of data.

With particular reference to FIG. 6A, wherein timestamping is performed directly within the general purpose application program instead of on separate files, timestamping an entry comprises initiating the timestamping function, such as by clicking on an icon on a toolbar, as shown in block 51. Alternatively, the user may use hot keys (predetermined key combinations or sequences), embedded commands (text or graphics embedded within the notebook which, when selected, execute the timestamp procedure), drop down or pop up menus, or any other desired method of initiating timestamping.

A hash is generated for the untimestamped entry or entries according to well-known principles, as shown in block 53a. The hash is sent to the timestamp authority selected during setup as shown in block 54. Optionally, the user may be provided with a choice of timestamp authorities before the hash is sent. Optionally, the hash may be sent to more than one timestamp authority.

The timestamp authority sends a timestamp certificate back according to well-known principles, as show in block 55. The timestamp certificate is then appended to the notebook, as shown in block 57.

With particular reference to FIG. 6B, wherein timestamping is performed on separate files instead of directly within the general purpose application program, the procedure is generally similar to that shown in FIG. 6A, with the exception of blocks 53b and 56.

As shown in block 53b, the hash is generated for a separate .TSX file. Generating the hash for a separate file has the advantage of permitting existing third party software, such as that of a timestamping authority (TSA), to operate so as to facilitate the timestamping process (such as the generation of the hash, the communication of the hash to the timestamping authority, receiving of the timestamping certificate, and appending of the timestamping certificate to the .TSX file).

As shown in block 56, the certificate is appended or otherwise associated with the .TSX file, as well as optionally being appended to the notebook. Preferably, appending the certificate to the notebook (and optionally appending the certificate to the .TSX file), comprises providing a textual and/or graphic representation of the certificate at the end thereof. That is, a certificate is preferably visible within the document.

It is worthwhile to appreciate that a timestamp certificate is typically merely a data file that contains, among other things, the time and date of timestamping. A timestamp certificate does not necessarily look like a certificate, although it may. When the timestamp certificate is displayed within the data file, it preferably has the appearance of a certificate. The displayed certificate preferably contains the time and date of timestamping and optionally also contains the identification of the timestamping authority.

Preferably, text within the certificate indicates what the timestamp applies to. For example, the text may indicate that the time stamp applies to all entries between the timestamp and a previous timestamp.

The method of the present invention may be used to timestamp audio and/or video data, such as that obtained either by importing a file or via real-time or previous recording. The time-stamping of real-time audio and/or video data may be useful in surveillance applications, so as to provide evidence of the time and date upon which an activity occurred and was recorded.

For example, a handheld portable digital video recorded may be used to record audio and video information. The video recorder may be in wireless communication with the Internet. Timestamping may be performed when commanded, such as by pressing a button on the video recorder, or may be performed periodically, such as every minute of recording.

As those skilled in the art will appreciate, the software used in the practice of the present invention may comprise a macro (such as a Microsoft Word macro), a Visual Basic for Applications (VBA) program, a Visual Basic (VB) program, or any other desired type of program.

It is understood that the exemplary method for timestamping documents described herein and shown in the drawings represents only presently preferred embodiments of the invention. Indeed, various modifications and additions may be made to such embodiments without departing from the spirit and scope of the invention. For example, the timestamped data may comprise a spreadsheet program, a database program, or any other desired type of program. Indeed, the data may comprises audio and/or video data. Thus, the notebook may contain any desired combination of text, graphics and/or other data. Further, information representative of a notebook entry other than a hash may alternatively be utilized in place of the hash.

Thus, these and other modifications and additions may be obvious to those skilled in the art and may be implemented to adapt the present invention for use in a variety of different applications.

1. A method for timestamping data, the method comprising selecting at least a portion of a data file and initiating a timestamping process for the selected portion.

2. The method as recited in claim 1, wherein selecting at least a portion of a data file comprises selecting less than the entire data file.

3. The method as recited in claim 1, wherein initiating a timestamping process is performed from within a software application program.

4. The method as recited in claim 1, wherein initiating a timestamping process is performed from within a general purpose software application program.

5. The method as recited in claim 1, wherein initiating a timestamping process is performed from within a software application program selected from the group consisting of a word processing program, a database program, a spreadsheet program, and a CAD program.

6. The method as recited in claim 1, wherein timestamping the selected portion of the data file is facilitated by making the selected portion of the data file into a separate file.

7. The method as recited in claim 1, wherein the selection is performed within a general purpose software application program.

8. A method for timestamping data, the method comprising initiating a timestamping process from within a general purpose software application program.

9. The method as recited in claim 8, further comprising selecting at least a portion of a data file, wherein the selected portion is to be timestamped.

10. The method as recited in claim 8, further comprising selecting at least a portion of a data file to be timestamped, the selection being performed within the general purpose software application program.

11. A method for timestamping a data file, the method comprising:
assembling a data file from a plurality of timestamped files;
making an entry into the data file using a desired application program;
initiating a timestamping function;
forming a hash of the entry;
transmitting the hash to a timestamp authority; and
receiving a timestamp certificate from the timestamp authority.

12. The method as recited in claim 11, wherein the hash is formed on a portion of the data file.

13. The method as recited in claim 11, further comprising forming a file which contains the entry and which is separate from a file, which contains the data file and wherein the hash is formed from the separate file.

14. The method as recited in claim 11, wherein the application program comprises a word processor.

15. The method as recited in claim 11, wherein initiating a timestamping function comprises clicking on an icon in a toolbar.

16. The method as recited in claim 11, wherein initiating a timestamping function is performed without exiting the document.

17. The method as recited in claim 11, wherein initiating a timestamping function is performed without exiting the application program.

18. The method as recited in claim 11, wherein initiating a timestamping function is performed without the user explicitly saving the document.

19. The method as recited in claim 11, wherein the document is assembled by concatenating a plurality of separate timestamped files.

20. A method for timestamping, the method comprising operating a switch to initiate a timestamping process for a recording device.
